(19) United States
(12) Patent Application Publication
(10) Pub. No.: US 2012/0019488 A1
(43) Pub. Date: Jan. 26, 2012

(54) STYLUS FOR A TOUCHSCREEN DISPLAY

(76) Inventor: John P. McCarthy, Pleasanton, CA (US)

(21) Appl. No.: 13/260,229

(22) PCT Filed: Dec. 14, 2009
(86) PCT No.: PCT/US09/67826

§ 371 Date: Sep. 23, 2011

(51) Int. Cl. G06F 3/033

(52) U.S. Cl. 345/179

(57) ABSTRACT

Embodiments of the present invention disclose a stylus 110 for use with a system having a touchscreen display 105 coupled to a processor 120. According to one embodiment, the touchscreen display 105 is configured to determine positional information of an object positioned within a display area of the touchscreen display 105. Furthermore, the stylus 110 includes a tip portion and housing, and is configured to transmit pressure and orientation information of the housing to the processor 120.

### BACKGROUND

Touchscreen displays enable a user to physically interact with objects and images shown on the display. Several types of touchscreen displays are available including resistive touch panels, capacitive touchscreen panels, and optical imaging touchscreen panels. Touch interaction is typically accomplished by a user touching the display with a finger or object. One such object is a passive object such as a stylus. Generally, a stylus falls into two disparate categories: 1) an inexpensive pen-shaped stylus that lacks electrical components and simply acts as a selection mechanism in the same way as a user's fingers, and 2) an expensive high-performance stylus that includes several complex electrical components for determining its relative position with respect to the display, in addition to a complicated configuration and setup process.

### BRIEF DESCRIPTION OF THE DRAWINGS

The features and advantages of the inventions as well as additional features and advantages thereof will be more clearly understood hereinafter as a result of a detailed description of particular embodiments of the invention when taken in conjunction with the following drawings in which:

FIG. 1 is an illustration of an exemplary computing environment utilizing a stylus and touchscreen display according to an embodiment of the present invention.

FIG. 2A is a top view of an optical touchscreen display using infrared sensors, while FIG. 2B is a top view of an optical touchscreen display using a three-dimensional optical sensor according to an embodiment of the present invention.

FIG. 3 is a simplified schematic diagram of the stylus according to an embodiment of the present invention.

FIG. 4 is a high-level block diagram of the electrical components of the stylus according to an embodiment of the present invention.

FIG. 5 is a flow chart of the processing logic for interfacing the stylus with a touchscreen display according to an embodiment of the present invention.

### DETAILED DESCRIPTION OF THE INVENTION

The following discussion is directed to various embodiments. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

There are constant innovations for enhancing the input and functional capabilities of a stylus used for computer display. Most users desire a stylus that can be utilized as an all-in-one replacement for other input devices such as a mouse and keyboard. On one hand, simple pen-shaped styli lack the functionality necessary for complicated tasks like simulated mouse clicks and/or mouse drag, while most high-performance styli emit infrared light for helping the computer system determine its precise location on the display screen. In addition, some styli may include functionality for handwriting recognition and other high end functions, but the components required for such capabilities ultimately makes the stylus less cost-effective for both manufacturers and consumers alike.

Embodiments of the present invention provide an enhanced stylus for a touchscreen display. According to one embodiment, the stylus includes at least one sensor for detecting the amount of pressure exerted on the touchscreen display, and at least one sensor for detecting the orientation, or angle of inclination of the stylus with respect to the touchscreen display. As most touchscreen displays are pre-configured to determine the location of an object proximate thereto, self-detection and calculation of position or location is not required by the enhanced stylus of the present embodiments. Accordingly, the stylus of the present embodiments can be immediately implemented in existing touchscreen displays. Furthermore, the stylus includes a simplistic configuration and a small number of electrical components, thereby reducing manufacturing costs and allowing for a cost-effective and functional stylus to be brought into the marketplace,

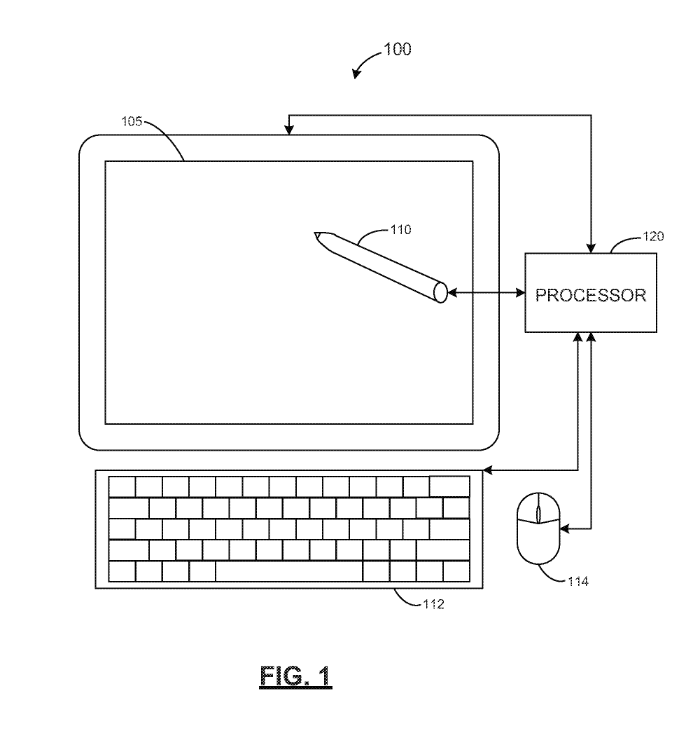

Referring now in more detail to the drawings in which like numerals identify corresponding parts throughout the views, FIG. 1 is an illustration of an exemplary computing environment utilizing a stylus and touchscreen display according to an embodiment of the present invention. As shown here, the computer environment 100 includes a touchscreen display 105, a computer processor 120, a keyboard 112, a mouse 114, and a stylus 110. In addition to the touchscreen display 105 being coupled to the computer processor 120, user input devices including stylus 110, keyboard 112, and mouse 114 are also coupled to the computer processor 120, In an exemplary embodiment, the input devices 110, 112, and 114 are all wirelessly coupled to the computer processor 120. However, stylus 110, the keyboard 112, and mouse 114 may include a wired connection to computer processor 120 instead of a wireless connection, Furthermore, computer processor 120 includes programming logic for receiving user input from each input device and manifesting the input onto the display screen, e.g. text entry, mouse clicks, etc.

Input devices such as stylus 110 or mouse 114 may be used to select an item or object shown on the display, i.e. a click event. If the cursor is pointing to an object on the display. which may be known as a mouse over event or hover event, information about the object can be displayed. In other embodiments, pointing to an object via the on-screen cursor can perform other functions such as highlighting a particular object. The function that is performed. by the computer processor 120 depends on the programming of the interface and the application.

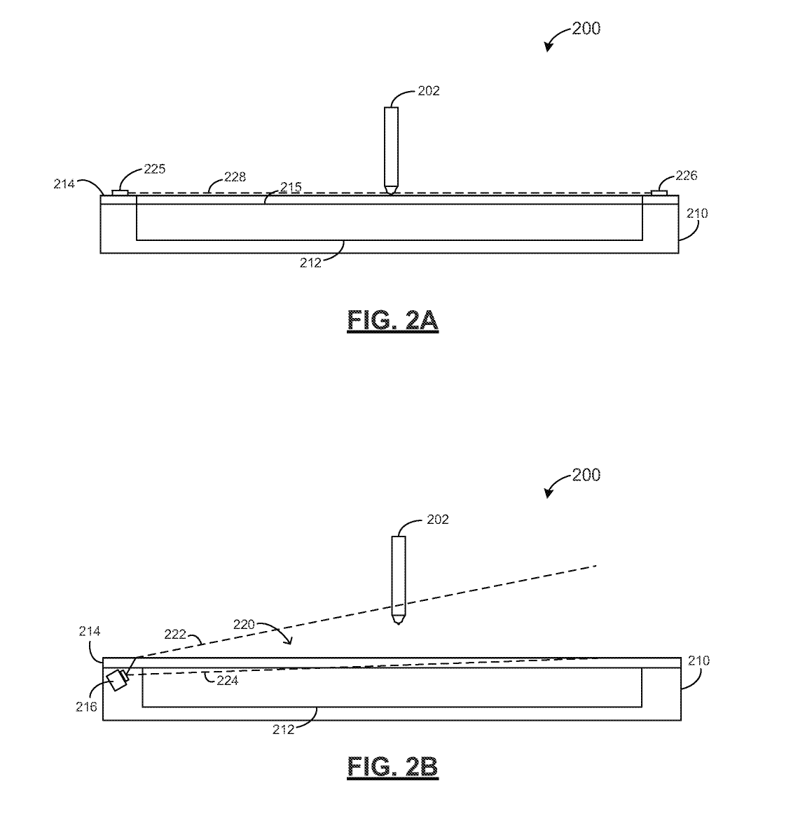

FIG. 2A is a top view of a two-dimensional optical touchscreen display, while FIG. 2B is a top view of a three-dimensional optical touchscreen display according to an embodiment of the present invention. Two-dimensional optical touch systems may be used to determine where an onscreen touch occurs. As shown in the embodiment of FIG. 2A, the two-dimensional optical touch system includes a display housing 210, a glass plate 212, an infrared emitter 225, an infrared receiver 226, and a transparent layer 214. The infrared emitter 225 emits a light source 228 that travels across the display surface 215 and is received at the opposite side of the display by the infrared receiver 226 so as detect the presence of an object in close proximity but spaced apart from the display surface 215 (i.e. display area). Infrared emitter 225 may generate light in the infrared bands, and may be an LED or laser diode for example. The infrared receiver 226 is configured to detect changes in light intensity, and may be a phototransistor for example. Light intensity changes are generally accomplished by mechanisms capable of varying electrically as a function of light intensity. In one embodiment, if an object, such as stylus 202, interrupts the light source 228, then the infrared receiver 226 does not receive the light and a touch is registered at the location where the interrupted light from two sources intersect. The infrared emitter 225 and the infrared receiver 226 in a two-dimensional optical touch system may be mounted in front of the transparent layer 214 so as to allow the light source 228 to travel along the display surface 215 of the transparent layer 214. In other embodiments, the optical sensors may appear as a small wall around the perimeter of the display.

A display system 200 utilizing a three-dimensional optical sensor is shown in FIG. 2B. As shown in this exemplary embodiment, the display system 200 includes a panel 212 and a transparent layer 214 positioned in front of the display surface of the panel 212. Surface 215 represents the front of panel 212 that displays an image, and the back of the panel 212 is opposite the front. A three-dimensional optical sensor 216 can be positioned on the same side of the transparent layer 214 as the panel 216. The transparent layer 214 may be glass, plastic, or any other transparent material. Moreover, display panel 212 may be a liquid crystal display (LCD) panel, a plasma display, a cathode ray tube (CRT), an OLED, or a projection display such as digital light processing (DLP), for example. Mounting the three-dimensional optical sensor 216 in an area of the display system 100 that is outside of the perimeter of the surface 215 of the panel 210 provides that the clarity of the transparent layer 214 is not reduced by the three-dimensional optical sensor 216.

According to particular embodiments, when the stylus 202 is positioned within the field of view 220 of the three-dimensional optical sensor 216, the sensor can determine the depth of stylus 202 from the display front surface 215. The depth of the stylus 202 can be used in one embodiment to determine if the object is in contact with the display surface 215. Furthermore, the depth can be used in one embodiment to determine if the stylus 202 is within a programmed distance of the display but not contacting the display surface 215 (i.e. display area). For example, stylus 120 may be in a user's hand and finger and approaching the transparent layer 214. As the stylus 202 approaches the field of view 220 of the three-dimensional optical sensor 216, light from the sensor can reflect from the stylus 202 and be captured by the three-dimensional optical sensor 216. Accordingly, the distance the stylus 202 is located away from the three-dimensional optical sensor 216 can be used to determine the distance the stylus 202 is from the display system 200.

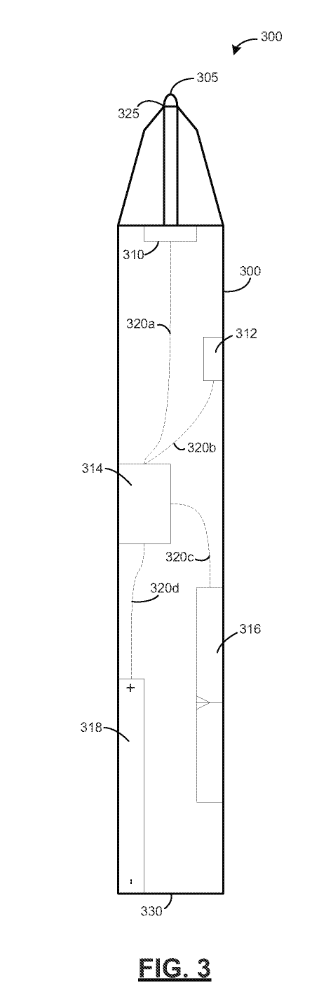

FIG. 3 is a simplified schematic sectional view of the stylus according to an embodiment of the present invention. As shown here, the stylus 300 includes a housing 300 and a tip portion 305. The stylus housing 300 is elongated from the front end 325 to the back end 330 and provides enclosure for electrical components including pressure sensor 300, orientation sensor 312, control unit 314, transmitter 316, and power unit 318, while electrical wires 320a-320d provide electrical connections between these components. The tip portion 305 of the stylus is coupled to the pressure sensor 310, which is configured to detect the amount of pressure applied from the tip portion 305 onto the front surface of the display panel. As shown here, the tip portion is formed at the front end 325 of the stylus 300 opposite the back end 330, and along or parallel to the horizontal axis passing through the front end 225 and back end 330 when the elongated side of the stylus is placed parallel to the normal surface.

In one embodiment, wire 320a is utilized to connect the pressure sensor 310 to the control unit 314. Orientation sensor 312 is configured to detect the orientation of the stylus with respect to the display panel. For example, the orientation sensor 312 can detect if the stylus is being held, by the user vertically, horizontally, or at any other angle of inclination with respect to the display panel. In a particular embodiment, a micro electro-mechanical systems (MEMS)-based accelerometer is utilized as the orientation or tilt sensor. However, a gyroscope, a magnetometer, or other sensor capable of detecting angular momentum or orientation may be incorporated. Accurate orientation detection is beneficial as it enables the computer processor to determine whether the stylus is being held correctly for use in angle-sensitive games or programs, such as a calligraphy or painting application.

Furthermore, as shown in FIG. 3, wire 320b enables electrical communication between orientation sensor 312 and control unit 314. Transmitter 316 provides wireless transmission of the pressure and orientation information to the computer system associated with the touchscreen display. Information may be communicated wirelessly by the transmitter 316 via radio frequency (RF) technology such as Bluetooth, or any other short-range wireless communication means. As discussed earlier, the wireless transmitter 316 may be omitted when the stylus is directly connected to the computer processor via a universal serial bus (USB) cable or any other wired interface means for establishing communication between a device and host controller.

In one embodiment, wire 320c connects the transmitter 316 to the control unit 314. Power unit 318 provides power to the control unit via wire 320d and may be a rechargeable battery, or any other low voltage power supply. In addition, the stylus may include buttons and other input mechanisms for simulating additional functionality of a mouse or keyboard device.

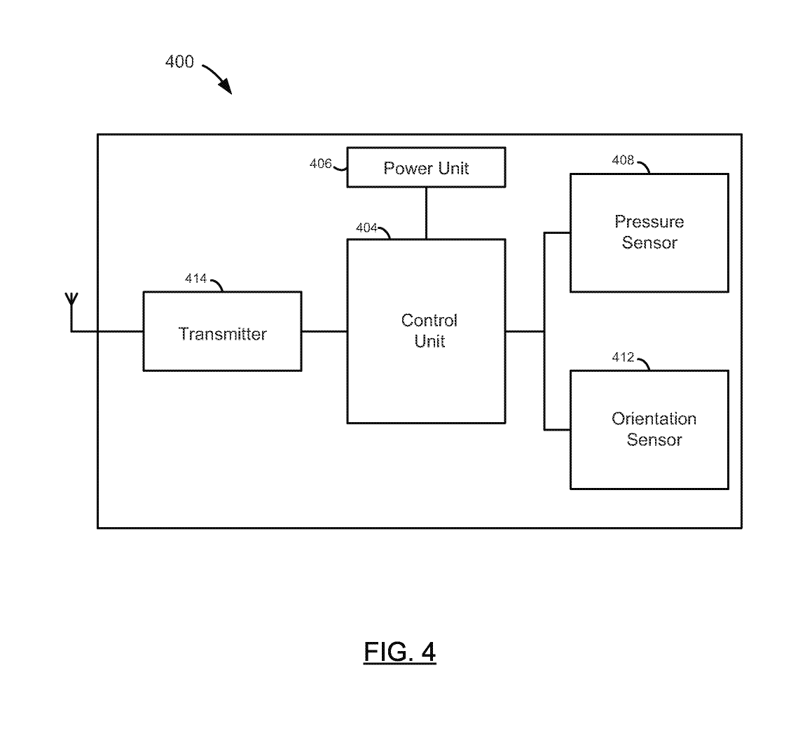

FIG. 4 is a block diagram of the electrical components of the stylus according to an embodiment of the present invention. According to the present embodiment, stylus 400 includes a power unit 406, control unit 404, pressure sensor 408, orientation sensor 412, and wireless transmitter 414. Power unit 406 is responsible for powering the control unit 404, which in turn provides power to the pressure sensor 408, orientation sensor 412, and wireless transmitter 414. In an alternate embodiment, the control unit 404 is omitted and power is supplied directly from the power unit 406 to pressure sensor 408, orientation sensor 412, and transmitter 414. The power unit may be activated upon movement of the stylus from a stationary position, or via a power-on switch or button on the stylus. When the tip portion of the stylus contacts the front surface of the touchscreen display, the pressure sensor 408 is configured to detect the amount of pressure applied thereto and send the pressure information to control unit 404 for further processing, or directly to the wireless transmitter 414. As discussed above, orientation sensor 412 is configured to detect angular placement of the stylus. In one embodiment, the orientation sensor 412 detects stylus orientation upon contact of the tip portion with the surface of the touchscreen display, and immediately sends such orientation information to control unit 404, or directly to the wireless transmitter 414 for further processing.

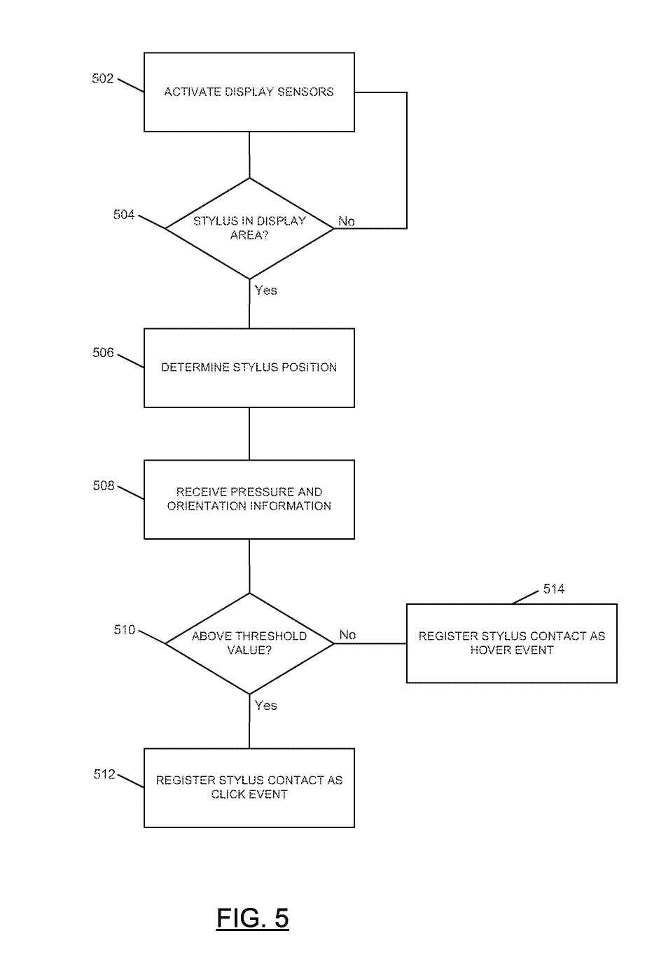

FIG. 5 is a flow chart of the processing logic for interfacing the stylus with a touchscreen display according to an embodiment of the present invention. In step 502, the sensors of the touchscreen display are activated by powering on the computer system. As described above, the sensors may be any sensor utilized in a touchscreen environment including, but not limited to, two-dimensional and three-dimensional optical sensors. In step 504, the sensors detect whether the stylus is at least within a display area of the touchscreen display. According to one embodiment, the display area is the area immediately adjacent to the front surface of the display, i.e. almost contacting. For example, the display area may be a few centimeters in front the display surface in a touchscreen environment utilizing a two-dimensional optical sensor (e.g. light source 225 shown in FIG. 2A), or the display area may be a few inches in front of the display surface in a touchscreen environment utilizing a three-dimensional optical sensor (e.g. field of view 220 shown in FIG. 2B).

Next, in step 506, the computer processor analyzes the data returned by the detection sensors and determines the position of the stylus with respect to the touchscreen display. The processor is configured to accurately determine the two-dimensional (i.e., x-y coordinates) or three-dimensional (i.e. x-y-z coordinates) positioning of the stylus, and in particular, a precise touchpoint location of the tip, or front portion of the stylus on the display screen.

Thereafter, in step 508, the computer processor receives pressure and orientation information from the stylus via the wireless transmitter. Based on the pressure information, the computer processer is configured to determine whether the stylus contact is applicable for selecting or activating an item (i.e. click event), or for dragging an item from one position on the screen to another position on the screen (i.e. hover event). Additional functionality may be determined based on the received pressure information such as zooming or page scrolling for example. In accordance with one embodiment, in step 510, the pressure information is compared to a preset threshold value for determining the type of stylus event. If the pressure is above the threshold value, or hard pressure, then in step 512 the stylus contact is registered as a click event for selecting or activating a particular on-screen item positioned at the touchpoint location of the stylus tip. By contrast, if the pressure is below the threshold value, or light pressure, then in step 514 the stylus contact is registered as a hover event or other secondary operation. Furthermore, the received orientation information may be used to analyze angular inclination of the stylus housing. Accordingly, various user input and movement operations are capable of execution through use of the enhanced stylus of the present embodiments.

Embodiments of the present invention provide a stylus for use with a touchscreen display. More specifically, an inexpensive and functionally-enhanced stylus is provided that communicates pressure and orientation information with a computer processor. As a result, the stylus of the present embodiments is capable of being utilized with today's touchscreen displays, with minimum set-up time and simple configuration options.

Many advantages are afforded by the enhanced stylus according to embodiments of the present invention. For instance, a low-cost stylus can be provided without sacrificing functionality. Conventional pen digitizers are extremely limited by the cost required to scale them to a large form factor. Embodiments of the present invention provide a functional and practical stylus capable of communicating status information to a computer processer associated with a touchscreen display.

Furthermore, while the invention has been described with respect to exemplary embodiments, one skilled in the art will recognize that numerous modifications are possible. Although exemplary embodiments depict a desktop computer as the representative touchscreen display and computing device, the invention is not limited thereto. For example, embodiments of the invention are equally applicable to other touchscreen environments such as a notebook personal computer (PC), a tablet PC, or a mobile phone having touchscreen capabilities. Furthermore. the stylus housing may be formed in any shape ergonomically suitable for use with a touchscreen display. Thus, although the invention has been described with respect to exemplary embodiments, it will be appreciated that the invention is intended to cover all modifications and equivalents within the scope of the following claims.

What is claimed is:

1. A system comprising:
a touchscreen display;
a processor coupled to the touchscreen display and configured to detect the presence of an object within a display area of the touchscreen display; and
a stylus having a housing and tip portion;
wherein the stylus is configured to transmit pressure information of the tip portion and orientation information of the housing to the processor.

2. The system of claim 1, wherein the stylus transmits information wirelessly via a wireless transmitter.

3. The system of claim 1, wherein the stylus includes a gyroscope, magnetometer, or accelerometer for detecting orientation of the housing with respect to the touchscreen display.

4. The system of claim 1, wherein the tip portion is coupled to a pressure sensor for detecting the amount of pressure applied from the tip portion onto the touchscreen display.

5. The system of claim 4, wherein upon contact of the tip portion of stylus with the surface of the touchscreen display, the processor analyzes the pressure information received from the stylus in order to determine a stylus selection event or a stylus hover event.

6. The system of claim 1, wherein the stylus includes at least one button for communicating user selection information,

7. A method for interfacing a stylus with a computer system having a processing engine, the method comprising:
detecting, via the processing engine, presence of the stylus within a display area of a touchscreen display coupled to the processing engine; and
determining, via the processing engine, the location of a tip portion of the stylus,
transmitting pressure information and orientation information from the stylus to the processing engine of the computer system.

8. The method of claim 7, wherein the stylus includes a gyroscope, magnetometer, or accelerometer for detecting orientation information.

9. The method of claim 7, wherein the tip portion of the stylus is coupled to a pressure sensor for detecting the amount of pressure applied from the tip portion onto the touchscreen display.

10. The system of claim 9, wherein upon contact of the tip portion of stylus with the surface of the touchscreen display, the stylus wirelessly transmits pressure information and orientation information to the processor, and
wherein the processor analyzes the pressure information in order to determine a stylus selection event or a stylus hover event.

11. A stylus for use with a computer system having touchscreen display and a processing engine, the stylus comprising:
an elongated housing having a front end and a back end opposite the front end, wherein the housing accommodates electrical components;
a tip portion that protrudes from the front end along a horizontal axis of the housing passing through the front end and the back end; and
a wireless transmitter configured to wirelessly communicate pressure information and orientation information with the processing engine of the computer system.

12. The stylus of claim 11, further comprising:
a pressure sensor coupled to the tip portion and configured to detect an amount of pressure applied from the tip portion onto a surface of the touchscreen display.

13. The stylus of claim 11, farther comprising:
a orientation sensor configured to detect the orientation of the stylus with respect to the display screen.

14. The stylus of claim 13, wherein the orientation sensor is a gyroscope, magnetometer, or accelerometer.

15. The stylus of claim 12, wherein when the tip portion of the stylus is in contact with the touchscreen display, the wireless transmitter of the stylus communicates the amount of pressure applied to the surface of the touchscreen display.
